(19) United States
(12) Patent Application Publication
(10) Pub. No.: US 2006/0277272 A1
(43) Pub. Date: Dec. 7, 2006

(54) Protocol for enabling digital media navigation, selection and mobile remote control of DVR devices

(75) Inventor: James C. Cantalini, New York, NY (US)

Correspondence Address: MORRISON & FOERSTER LLP, 1650 TYSONS BOULEVARD, SUITE 300, MCLEAN, VA, 22102, US

(73) Assignee: Gist Communications, Inc., New York, NY (US)

(21) Appl. No.: 11/442,601

(22) Filed: May 30, 2006

Related U.S. Application Data
(60) Provisional application No. 60/685,487, filed on May 31, 2005.

(51) Int. Cl. G06F 15/16

(52) U.S. Cl. 709/217

(57) ABSTRACT

Described is a communications protocol that enables a client device (e.g., a digital video recorder) to communicate with a server (e.g., a database server that stores user-related information and recording instructions). The communication protocol allows a device manufacturer to create and implement enabling software components that would reside on the device.

### REFERENCE TO RELATED APPLICATIONS

This application claims priority to U.S. Provisional Application No. 60/685,487, filed May 31, 2005, the contents of which are hereby incorporated by reference.

### FIELD OF INVENTION

This invention relates to a communications protocol that enables a client device (e.g., a digital video recorder) to communicate with a server (e.g., a database server that stores user-related information and recording instructions) via the Internet.

### BACKGROUND

Digital recording devices, such as digital video recorders, have allowed viewers to schedule the recording of programs in advance and then view the program at any convenient time. Typically, the programming of these recorders occurs at the viewer's home in the presence of the recorder. Unfortunately, it is not always convenient to schedule the programming at home and, therefore a need exists for methods for remotely managing recording devices.

Currently, there are a few products that enable remote control of set-top boxes and/or recording devices by computers using an Internet connection. Examples of these systems are shown in the U.S. patent applications Ser. No. 09/872,491 to Istvan, et al., U.S. Ser. No. 09/828,663 to Susskind and U.S. Ser. No. 09/896,066 to Kosar, et al., and in U.S. Pat. No. 6,697,467 to Schultz et al.

These references describe systems in which web enabled devices such as a server are able to remotely configure a recording device. However, these references rely upon the transmission of commands from a computer/server to a device (e.g., using an “always-on” Internet connection.). There is currently no system that allows a recording device to initiate a connection to a server in order to send and/or retrieve information.

### BRIEF DESCRIPTION OF THE DRAWINGS

FIG. 1 is a flow diagram showing the components of one embodiment of the UGuide system.

FIG. 2 is an example of a client request message method call in XML-RPC format.

FIG. 3 is an example of a server response message in XML-RPC format including a record instruction.

### SUMMARY

Described are systems and methods which enable a client consumer electronic device, such as a recording device to communicate directly with a data server using a communications protocol. The communication protocol allows a device manufacturer to create and implement enabling software components that would reside on the device.

One embodiment is a system for scheduling recordings on a client electronic device. The system includes a server configured to send a message comprising instructions to record a program to a client electronic device utilizing a predetermined protocol, wherein the predetermined protocol is configured to permit communication between a server and a client electronic device and enables remote scheduling of recording on the client device; a network that provides a communication link between the server and a client electronic device; a client electronic device configured to receive the message from the server utilizing the predetermined protocol, and wherein the client device comprises a unique Device ID; and an application on the client electronic device configured to execute the instructions to record the program on the client electronic device.

Preferably, the network is a one-way broadcast network, or a two-way internet connection. A preferred broadcast stream is a program stream of a cable or satellite television system.

Preferably, the client electronic device is a digital recording device or a digital video recorder. Preferably, the recording device is configured to transmit a message to the server. Preferably, the message includes a recording conflict alert or a scheduling confirmation. Preferably, the message is in XML-RPC format.

Preferably, the client electronic device is configured to provide its unique Device ID to the server prior to the server sending a message to the client electronic device. The message may include the client electronic device's unique Device ID, timestamp, version of the communication protocol, and/or message type ID.

Another embodiment is a method for scheduling recordings on a client electronic device. The method includes receiving on a client electronic device a message comprising instructions to record a program utilizing a predetermined protocol, wherein the client electronic device comprises a unique Device ID; and executing the instructions to record the program on the on the client electronic device utilizing an application of the client electronic device. Preferably, the method further includes transmitting a message from the client electronic device to the server.

### DETAILED DESCRIPTION

Described are methods and systems that allow for a client consumer electronic device, such as a recording device, to communicate with a data server. The methods and system utilize a communication protocol that allows a device manufacturer to create and implement enabling software components that would reside on a recording device, thus integrating the device with an external service such as the UGuide service.

The UGuide service enables the use of mobile phones or other handheld wireless devices to receive, view and navigate data, including digital recording device program guides and personalized content recommendations. The UGuide service also enables users to remotely control the scheduling of recordings on digital recording devices, for example DVRs. The digital recording device application that allows users to perform these tasks on their handheld wireless devices is referred to as the “UGuide” herein. The recording of programming utilizing the UGuide is preferably deployed as a resident application on a cell phone or other wireless device. Alternatively, or in addition, the UGuide can include a website-based service.

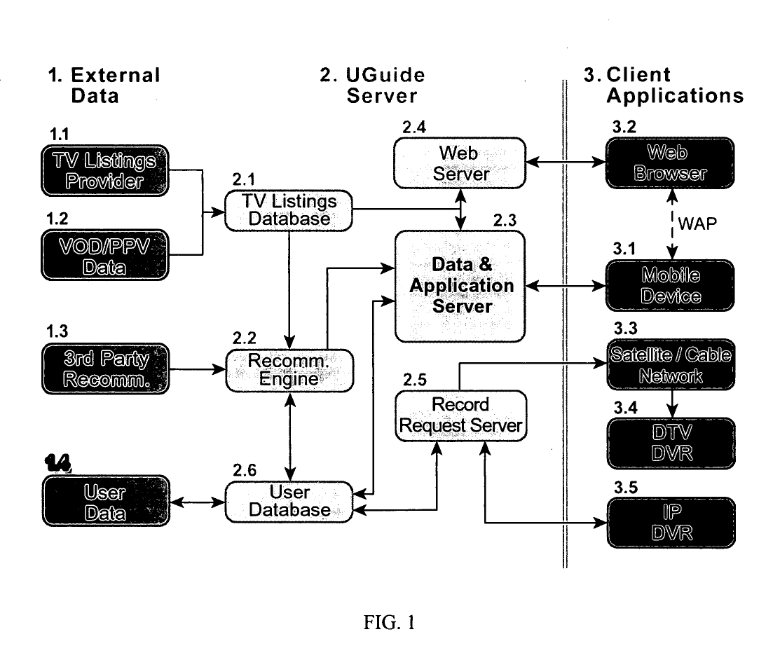

Preferred components of the UGuide service are illustrated in FIG. 1. A detailed description of each component listed in FIG. 1, and an explanation of how data flows between the components, is included below.

1. External Data Sources

1.1 TV Listings Provider

The richness of the application features (for example search functions for genres, etc.) is dependent upon the quality of the integrated TV listings data. In the United States, TRIBUNE MEDIA (TMS) is an example of a TV listings data provider. The UGuide imports data from the Listings Provider into the TV Listings Database (2.1).

1.2 VOD/PPV Data

In the case of Video-On-Demand and Pay-Per-View systems or other operator-specific offerings, the UGuide can import listings data from these external sources into the TV Listings Database (2.1).

1.3 Third-Party Recommendations

Third-parties, such as operators or magazines, can provide editorial recommendations, which can be imported by the UGuide Recommendation Engine (2.2).

1.4 User Data

The UGuide preferably allows for the end consumer to create and edit his/her own personal profile. User-supplied data and/or other inputs are stored in the User Database (2.6).

2. UGuide Server

The UGuide server can run on standard open-source software platforms, which are supported by leading hosting operations. Server code and production processes can be written, for example, using JAVA, PYTHON, APACHE TOMCAT, JAVA servlets and MYSQL databases which can run on the LINUX operating system.

The UGuide server software can run on a general purpose, programmed digital computing device which includes a central processing unit (CPU), random access memory (RAM), non-volatile secondary storage device such as a hard drive, one or more network interfaces, and optionally a keyboard and monitor display. Program code, including software programs, and data can be loaded into the RAM for execution and processing by the CPU and results generated for display, output, transmittal, or storage. A specific example of suitable computer server hardware would be a DELL(R) POWEREDGE(R) 1850 server, with dual INTEL(R) XEON(R) 3.0 GHz processors, 2 GB RAM, and a 73 GB hard drive, and on-board NICs (Network Interface Cards).

2.1 TV Listings Database

The TV Listings database preferably stores all the TV listings data associated with a given data provider (1.1). The method of the invention uses the data schema supplied by the data provider and, as described above, relies on the object oriented capabilities of the system architecture to provide access to data provider-specific data attributes. As such, it is likely that there will be multiple listings databases corresponding to relationships with data providers in multiple countries/regions.

2.2 Recommendation Engine

The Recommendation Engine (RE) is capable of generating relevant and unique content recommendations based on a user's profile. Recommendations are generated using optimized algorithms capable of identifying recommendations based on:
explicit user choices (a user says s/he likes actor ‘A’ or director ‘B’)
implicit user choices (program attributes are harvested from a user's record history)
collaborative filtering-based recommendations
third-party recommendations (1.3)

The set of algorithms used can be customized for a given client, and can be delivered via a web-based EPG, mobile phone, or directly to a user's set top box.

2.3 Data & Application Server

The Data & Application Server provides a framework whereby UGuide services can be added and made available to clients. The services are used by web servers, web services, UGuide clients, and third parties. These services carry the business logic and provide the interface to components such as the TV listings database (2.1), user database (2.6), recommendation engine (2.2), and recording scheduler. A mobile UGuide client application (3.1), such as the J2ME MIDlet, connects to the Data & Application Server using TCP/IP. It will authenticate, may transmit user preferences, and load and display TV listings data or recommendations. Depending upon the request, the server in turn will update the user database (2.6), request listings from the TV listings database (2.1) or recommendations from the recommendation engine (2.2). A digital recording device will use the UGuide protocol to communicate with the server to identify itself, request record instructions, and if possible update the status of record instructions.

The server architecture allows the implementation of customizable user interfaces such as an HTTP or WAP server or the integration with SMS or other wireless services. All can use the same underlying services made available by the Data & Application server and can carry the same user from a mobile device to a web browser to a digital recording device.

2.4 Web Server

The web server is built around APACHE, APACHE TOMCAT, servlets and JSP. The web user interface display (HTML, CSS, etc.) has been separated from the application server code, so that web interfaces can be quickly customized. This allows the system to support, when necessary, a variety of web clients including standard web browsers and browsers optimized for mobile devices. Commercial branding and functional customization is also facilitated.

2.5 Record Request Server

The ‘Record Request’ Server (RRS) is responsible for satisfying requests for ‘record instructions’. A client process/program requests the record instructions for a given time period, and the RRS returns said record instructions. The record instructions contain the information required by the digital recording device to schedule a recording (channel, date, time, duration, etc.) along with any additional information that is needed to support features/functionality required by the customer. For instance, a password to ensure that only users with proper access can remotely program a digital recording device or additional data along with each record instruction to help the digital recording device perform conflict resolution—i.e. record instruction ‘priority’.

2.6 User Database

The user database stores all the user data requiring access, subject to the specifics of a given business relationship.

It is possible that the user data is stored in another company's database (1.4) and the UGuide system will only have access to the subset needed to perform the requisite tasks for said company.

3. Client Applications

Users can utilize the UGuide from an array of mobile devices in order to program their digital recording devices. The UGuide platform provides the following client-side components:

3.1 Mobile Device Application

The UGuide mobile client application is written in J2ME, so it can run on a variety of JAVA ME KVM enabled MIDP devices supporting of CLDC 1.0 and MIDP 1.0 or higher. Application JAR size is preferably kept low at about 64K, so it can work on a wide array of devices which support a KVM. The UGuide mobile client can also be implemented for native PALM, BREW, or WINDOWS CE platforms. Since other platforms like BREW and WINDOWS CE support internet protocols, no changes are necessary to the UGuide server architecture to enable network data access. The client can be flexible in the quantity of data fetched from the server and cached, depending upon the channels selected and device memory, with typical usage of 40K of data fetched. All server-side functionality has been separated from presentation. The UGuide mobile client communicates using TCP/IP to the server. Additionally, if a very narrow, precise functionality is desired then SMS (text messaging) can be initiated from the mobile device to send record or search instructions, i.e. “Record Program X at 8PM”.

The UGuide Mobile application offers robust functionality that helps users to navigate the vast amount of available digital content. The product feature set includes, but is not limited to:

User registration and login: Only registered subscribers will be able to use the service; users create their own ID's for login.

Personalization: Registered users are preferably able to set up profiles, specify favorite programs and favorite channels, and create personalized program guides.

Recommendations: Every day, the user can receive a number of recommendations for programs that closely match the user's content preferences (e.g., preferred movies or TV programs).

Remote Digital Recording Device Recording: The user is able to create record requests for specific programs; these requests are stored on the UGuide server, where they are either broadcast to or retrieved by the user's digital recording device, which then schedules corresponding recordings.

TV List: A hierarchical, tiered-menu navigation that enables users to quickly “drill-down” to a specific program. Step 1: From a scrollable list displaying ‘Today’ plus the next 6 days, the user select a day (e.g., Wednesday); Step 2: From a scrollable list displaying a 24 hour time period, the user select a time (e.g., 8 PM); Step 3: User then selects a channel (e.g. 4 NBC); Step 4: The title of the appropriate program (e.g., the program airing on Channel 4 at 8 PM on Wednesday) is displayed. The user can select the title to see a full Program Description.

Full Program Description: Displays available program information, including start/end times, channel, genre, rating and synopsis; user options include Record Program and Add to Favorites.

Favorite Programs: An editable list of programs specified by the user as Favorites.

Scheduled Recordings List: A list of pending recordings that have been scheduled on the user's digital recording device via the UGuide.

Search: Keyword search for title, actor, director, or genre; results will include any programs in current listings that match Search criteria.

Reminders: The user will be able to schedule a reminder for a listed program and receive an alert before a desired program starts.

Impulse Recording: The user will be able to key in date, start time, duration and channel to create a record request whenever desired, without the need to view a specific program description.

3.2 Web Browser

The UGuide user interface can alternatively be served by a website. Should a local application on the mobile device (3.1) not be practical due to cost or operator issues, the mobile device can access a WAP site.

The web-based client application provides similar functionality to the mobile application, and can be offered as a complement.

3.3 DTV Digital Recording Devices

In a broadcast implementation, the Record Request Server (2.5) will preferably use the digital TV transport stream to broadcast all record requests using the communication protocol described herein to all users within the broadcast network. Each individual request is targeted to a specific digital recording device's hardware device ID. On the client-side, each digital recording device receiving the broadcast stream constantly “listens” for its package, which is marked with the digital recording device's unique device ID. Upon receipt of a data package, the scheduling component of the digital recording device translates the requests into record instructions and adds the desired programs to the list of scheduled recordings stored on the user's digital recording device.

3.4 IP Digital Recording Devices

Digital recording devices and Media Center PCs that are enabled with ‘back channel’ IP capability are able to send as well as receive information. Messages (such as recording schedule conflicts) can be sent to and received from the Record Request Server (2.5) by a digital recording device using the communication protocol described herein. To enable devices with this functionality, a digital recording device manufacturer or media-center software provider may implement only a client to the protocol. The protocol is designed to be flexible, allowing the digital recording device manufacturer to implement only as little or as much functionality as they are willing to. For instance, there are no software user interface requirements. The protocol supplements the existing digital recording device record software by allowing an additional input for record instructions. For a networked device, this means opening an IP connection, authenticating, and reading record instructions. In a broadcast environment, the device would have to read the instruction from the broadcast stream.

As described above, the communication protocol enables the ability to remotely control the scheduling of recordings on recording devices enabled with the communication protocol through a variety of transfer mediums, including broadband or dial-up Internet connectivity as well as cable and satellite television systems. In a preferred embodiment, the communication protocol would be used by third-party systems and/or devices, such as a satellite or cable network (3.3), a DVR that receives a data stream from a satellite or cable operator (3.4) or a DVR with the ability to connect to the Internet (3.5.)

The system preferably includes generation and import of recording requests, and the processing and delivery of these requests to various kinds of recording devices through multiple transport mechanisms. The communication protocol allows for the communication between the consumer electronic device and the external service, however, the communication protocol may not actually control the scheduling and recording of programming on the recording device. Another software component resident on the client recording device may utilize the requests received by the communication protocol to schedule recordings.

Preferably, the consumer electronic device is a recording device, such as a digital video recorder. Possible recording devices include, but are not limited to, set-top DVRs in the. home (such as TiVo's), personal computers equipped with TV tuner cards and digital video recording capabilities, mobile TV and video viewing devices, game consoles (such as the Sony PlayStation or Microsoft X-Box), personal video recorders that store and access files on a remote server (network PVRs), etc. The consumer electronic device may be a multituner device. The consumer electronic device can receive instructions from the server over the Internet or over a broadcast stream, or the consumer electronic device, using the communication protocol, can retrieve instructions from the server over the Internet. The broadcast stream may be, for example, a program stream of a cable or satellite television system. Preferably, the consumer electronic device has a unique Device ID and the server identifies the consumer electronic device utilizing the Device ID.

In addition to or alternatively, preferably, the consumer electronic device transmits messages to the server using the communication protocol. The messages transmitted to the server may include, for example, recording conflict alerts or scheduling confirmations.

The communication protocol enables the mobile, remote scheduling of recordings on recording devices, such as DVRs, via means other than a website interface by enabling communication between the recording device and the server. Accordingly, the communication protocol can add valuable functionality to existing and future set-top boxes, by allowing for the exchange of information between a DVR consumer electronic device and a server. This information may include recording instruction or additional, as yet unspecified, services.

A scheduling and recording application, such as the GIST UGuide application, can enable the use of mobile phones or other handheld wireless devices to receive, view and navigate data, including digital recording device program guides and personalized content recommendations. The application can also enable users to control the remote programming of digital recording devices, for example digital video recorders. The application, however does not communicate with the user's recording device. Rather, the communication protocol provides a means for a client DVR to communicate with a service associated with the scheduling and recording application.

To use the scheduling and recording application, preferably a consumer creates and activates an account with an external service, for example the UGuide service, by registering either on a website or via a downloaded application on a cell phone (or other mobile communication device.) Once the user has registered, s/he preferably is able to receive, view and navigate personalized content recommendations television program listings and program descriptions. To schedule a recording of a program (including a Recommended program), the user may select a Record option on a program description screen, thereby creating a recording request. The recording request may be routed to an external server where it is stored in a database. Delivery of recording requests to the DVR can be accomplished in a variety of manners.

In one embodiment the recording device is equipped with a backchannel capability that connects the device to an external server via the Internet at scheduled intervals, retrieving any new requests, such as recording requests, that have been created by the user or by the server administrator. The user's recording device can translate these requests into recording instructions, which would then be added to the list of scheduled recordings on the recording device.

The core components that enable the user's remote control of the recording device through a backchannel may include the following: A) a database server that stores user-related information and recording requests; B) the communication protocol that allows a DVR to communicate with the server, retrieve the recording instructions and schedule specified recordings. The communication protocol allows a device manufacturer to create and implement enabling software components that would reside on the recording device and would implement the instructions, thus integrating their device with the external server system without the need for custom software development.

An alternative implementation for delivering requests from the external server to the recording device utilizes a broadcast stream to deliver the requests. In this embodiment an external server with broadcast capabilities, ‘pushes’ program recording information to a communication protocol-enabled DVR via a privately or publicly owned network.

In this broadcast implementation, the set-top box does not initiate a download nor retrieve information; instead, recording instructions are included in the data stream that is delivered to the set-top box by the programming provider, for example, a cable or satellite operator. Recording instructions from all users are collected and stored on a scheduling server. These stored instructions are sent to the signal transmission system (i.e., a satellite or cable network) and then broadcast to all set-top boxes via an out-of-band frequency. Each recording instruction preferably includes a unique identifier, corresponding to the specific set-top box for which the instruction is intended. This will ensure that each DVR receives only the relevant recording instructions.

The nature of the “one way” broadcast transmission precludes the set-top box from sending a confirmation that a recording has been scheduled. To increase the likelihood that the DVR will receive the recording instructions prior to the start of a desired program, preferably the request data is repeatedly broadcast to the set-top boxes, using a scheduling algorithm to optimize delivery.

There are number of ways to substantially improve the reliability with which instructions are received by a given set-top box in a broadcast network. These methods of improving reliability include, but are not limited to, adding ‘intelligence’ to the scheduling algorithm. For example, preferably the scheduler is programmed so that there are multiple time periods during which record instruction(s) can be sent. The first period would begin upon receipt of the record instruction—regardless of where it came from (web, email, SMS, voice commands received via phone and translated by a computer, etc.) The second time period, which is typically the longest period, corresponds to a time after the first time period ends and before the third time period begins. During the second time period, transmission of record instruction(s) targeted to a specific recording device, occurs at a set interval, perhaps once every 15 minutes.

The third time period represents period of N minutes before the requested record time of the program(s)—plus, preferably, the amount of time it takes to broadcast an instruction from the server responsible for sending instructions and devices on the network. For example, if a user chooses to record an episode of ‘Friends’ at 8pm, ‘N’ might be 15 minutes, and assuming it takes 2 minutes to both send and receive a message, then the third time period would start 17 minutes before the requested record time by the user. Starting at 17 minutes before the requested record time, the scheduling algorithm would instruct the server responsible for sending the instructions to repeatedly send the record instructions at an interval shorter than the interval used for the second time period—keeping bandwidth cost considerations in mind. For example, the third time period may be once a minute.

In the broadcast embodiment the recording device manufacturer utilizes the communication protocol, enabling the recording device with the capability to recognize and receive device-specific recording instructions. In addition, preferably the receivers, such as set-top boxes, that are deployed in the broadcast network are able to receive data without being tuned to a specific channel. Preferably, the broadcast programming provider, such as a satellite or cable operator, has a delivery mechanism in place for the broadcast transmission of data to system set-top boxes. Preferably, the broadcast system is able to receive and/or retrieve recording instructions from a scheduling server.

The communication protocol provides a means for communication between a client consumer electronic device and an external server. By being standards based and flexible, it is possible to quickly implement requests according to needs of the manufacturer and capabilities of a client electronic device. Further, the communication protocol provides the ability to add additional services in the future.

The communication protocol can provide a variety of messages to the recording device. Preferred messages include recording instructions. This communication protocol may be applied to a wide variety of consumer electronic devices including Media Center PCs.

Preferred components of a system utilizing the communication protocol include: 1) a network, 2) a server, 3) a client, 4) a digital recording device such as a DVR, 5) a user, 6) an application. The network is a means of connecting of devices, computers, and services over Internet or Broadcast communication protocols. The server is a machine that provides resources to the network. The client is a device that accesses resources over the network. A DVR is a specialized client that can record live or streamed television programs. A User is a person logged in on a client. An application is a program that executes on a client.

The communication protocol preferably requires that each client have a unique Device ID, which is known to the server. In a preferred embodiment of an IP implementation, the client will present its unique Device ID and query the server for messages. In a preferred embodiment of a broadcast implementation, the server will broadcast individual messages targeted to the unique client Device ID.

Messages contain information carried by the communication protocol. Messages are preferably either verbose XML for development or reference implementations of the communication protocol, simple XML for implementations such as XML-RPC, or are binary for broadcast and for compact profile implementations of the communication protocol. The descriptions of message attributes below are for verbose messages, which better describe the message attributes.

All generic messages preferably contain the same constituent information to be generated by the server or client issuing the message as follows: unique message ID, timestamp, version of the communication protocol, and message type ID.

Each generic message type also preferably has several optional components. The optional components may be honored by the client, depending upon the extent to which the client device profile implements the communication protocol.

The message ID is generated on the client or server for each new message it creates. Preferably, this ID has a 16-byte value and is globally unique.

The timestamp indicates the local time that the message was generated. Preferably, the timestamp is in ISO 8601 format.

The version of the communication protocol indicates the version of the data format. Preferably, the version is a string identifying the version of the data format e.g. “1.3”.

The message type ID indicates the type of message being delivered. Preferably the message ID is an integer identifying the type of this message e.g. 3 for “record instruction”. Current message types and ids are, in order, Null Message=0, Status Message, Error Message, Identify Message, Record Instruction, Delete Instruction.

The message priority is an optional indicator identifying the messages priority. Preferably, the message priority is an integer.

A null message is an empty message, which is an extension of a generic message. It can be used for testing or heartbeat. It has no special attributes.

A status message is sent from the client to the server. In a preferred embodiment, status messages can be used to communicate information from the recording device to the user. For example, the DVR could generate a message confirming that a desired recording has been scheduled, or send a message alerting the user to a conflict between a desired recording and one that has already been scheduled on the device. Status messages are preferably delivered from the server to a user's mobile device.

Error message are sent from the client to the server. In a preferred embodiment, error messages can be used to alert a user to the existence of a technical problem on the recording device. For example, there may not be enough room available on the device to record a desired program. Error messages are preferably delivered from the server to the user's mobile device.

An identify message is an extension of a generic message which is sent from the client to the server to establish a communication protocol session. The client will identify itself to the server by including its unique Device ID.

A record instruction message is an extension of a generic message, which is sent from the server to the client to indicate what programs to record. The client will preferably be sent many record instructions over time. It is preferably specific, indicating the channel, local time, and duration of the program. It can also be less specific i.e. allowing the client application to determine the channel at record time by looking up a station identifier or allowing the client application to search for a program in its own guide data based on program metadata. The record instruction preferably takes effect as soon as the first program is located or at the start date and time of the program. When a program is specified using start date and duration, this information can also be applied to program intervals, which may include partial or multiple programs, e.g., 2-6 PM.

The record instruction preferably includes one or more attributes. Record attributes may include event time attributes, event location attributes, metadata attributes, and record detail attributes.

The record time attributes may include the record frequency. The record frequency supports specification of record frequency (once, daily, weekly), or every time the show is aired. The latter preferably requires program title or other sufficient program metadata be present to identify a program. This will usually be present. If record frequency is absent, preferably the record frequency is once.

A record frequency of once preferably means to record the first or only program specified by this instruction. A record frequency of daily preferably means to record the program specified by this instruction once daily. A record frequency of weekly preferably means to record the program specified by this instruction on the same day of every week. A record frequency of every preferably means to record all occurrences of the program specified, regardless of its airtime.

Another record time attribute is the start date and time. This value indicates the start airdate and time for the program to record. The time is preferably in local or universal time.

Another record time attribute is the duration of the recording. Preferably the duration is an integer length for the recording in minutes.

The time padding record time attribute supports requests for recording a number of minutes before and/or after the program airs.

The expiration time attribute is an instruction to cease the record instruction in effect after the date and time specified. The DVR is at liberty to remove recording instructions created after receiving this message after this date and time. If no expiration is present and frequency is more than once, then this record instruction preferably should be considered to be ongoing.

The channel number is an event location attribute. Preferably, this is the display integer channel number, which corresponds to the analog or cable channel number. This may also be the DTV major-minor channel numbers e.g. “2-0”. This will usually be present but is optional.

The service identifier is an event location attribute and may include one ore more of the following: a) Digital Video Broadcasting (DVB) locator, b) service name, c) URL to an IP stream, and c) Program and System Information Protocol (PSIP) Transport Stream ID.

The event metadata may include one of several optional identifiers. The title is string metadata for the event title. The episode is string metadata for the event episode name or number. The description is string metadata for the event description. The year is string metadata for the event integer year the program was created. The genre is string metadata for the genre of the program. The rating is metadata related to the rating of the program. The ratings will be the listings rating information for the program. Preferably parental control issues can be handled by the DVR or television. The image metadata may be a displayable image associated with the show.

The messages may also include one or more record detail attributes. A record flag is record detail attribute that indicates whether it is a record instruction, in case it is just an informational recommendation. Since this is usually true, preferably the default is true if not present.

Record title is a record detail attribute that supports recording only based on matching program title in client guide data. Preferably, the system supports recording via exact, prefix, or substring match on the title attribute.

Record genre is a record detail attribute that supports recording based on matching program genre in client guide data or supports recording via exact match on the genre attribute.

Record show is a record detail attribute that supports recording shows which match some specified criteria. Preferably, only first run programs are recorded.

Record repeats is a record detail that specifies whether only first run events or first run events and repeats should be recorded. Preferably, if this fails only first run events are recorded.

Record syndicated programs is a record detail that specifies whether to record programs in syndication. Preferably, if this indicator is false, only “network” events and not those in syndication are recorded.

Record protected is a record detail that supports specification of a protection state on the DVR of the recording. Preferably, the recording can be either be flagged as protected from routine deletion or purgeable when needed.

Record quality is a record detail that supports specification of recording quality. Higher quality usually uses more recording storage space. Preferably, quality specifications include best, high, medium, and low.

Record user is a record detail that is a string identification of the user who requested the record instruction. This usually reflects users of the DVR. e.g. Dan, Dad.

A record recommendation flag is a record detail flag indicating whether a record instruction was a recommendation. Record origin is a record detail that is a string identifying the origin or sponsor of a record recommendation i.e. a company or name, a user name or friend's name.

Record priority is a record detail that supports specification of a recording priority. Preferably, it is an integer priority (1-10). If there are conflicting record instructions, then higher priority programs will win conflicts.

Another type of preferable message is a delete instruction message. A delete instruction message is an extension of a generic message, which is sent from the server to the client to indicate which record instructions to delete. The delete message instruction message preferably may include several of the record instruction attributes discussed above. These attributes serve to match record instructions previously received by the client, which should be removed from the client's list of record instructions. Optional parameters allow the deletion of recording files and other information that may be associated with the original record instruction. It is also possible that the instruction flagged for deletion by this message no longer applies. In this case, preferably the client will perform no action after receiving this message.

Preferred delete message attributes include event time attributes, event location attributes, record detail attributes, and record file attributes. Preferred event time attributes include record frequency, start date and time, duration, and time padding attributes. Preferred event location attributes include, channel number and service identifier attributes. Preferred record detail attributes include record flag, record title record genre, and record show, user and delete attributes. Preferred file attributes include recordings and cleanup. The recordings file attribute is a flag to delete all recordings associated with the original record instruction. Preferably, the recordings file attribute is false if not present. The cleanup file attribute is a flag to delete images ads, and/or other meta-data associated with the original record instruction. Preferably, the cleanup file attribute is true if not present.

Yet another preferred type of message is a text message. A text message is an extension of a generic message that is sent from the server to the client containing human-readable text messages. These may be sent from a service provider or other entity via the communication protocol server.

The underlying IP communication protocol will preferably utilize XML-RPC. XML-RPC uses remote procedure calling using HTTP as the transport and XML as the encoding. XML-RPC is designed to be as simple as possible, while allowing complex data structures to be transmitted, processed and returned.

### EXAMPLE 1

### XML-RPC Client Message Method Call

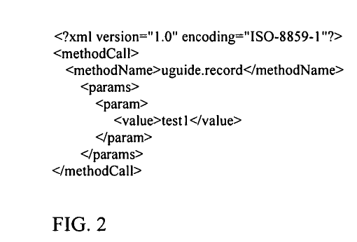

The method called indicates the action taking place (e.g. record=>get all my record requests) and any parameters supplied are required by the action (e.g. Device ID for record( ).) FIG. 2 is an example of a client request message method call in XML-RPC format. Client request messages can be transmitted at predetermined intervals, and may be repeatedly sent N times. For example, a client request message designed to retrieve record instructions for the DVR could be sent from the client to the server every 10 minutes, polling the server for any record instructions that have been uploaded to the server since the last client request had been made. The client message could also be a status message such as an update (e.g., confirming that a program recording has been scheduled) or an alert.

### EXAMPLE 2

### XML-RPC Server Response Message

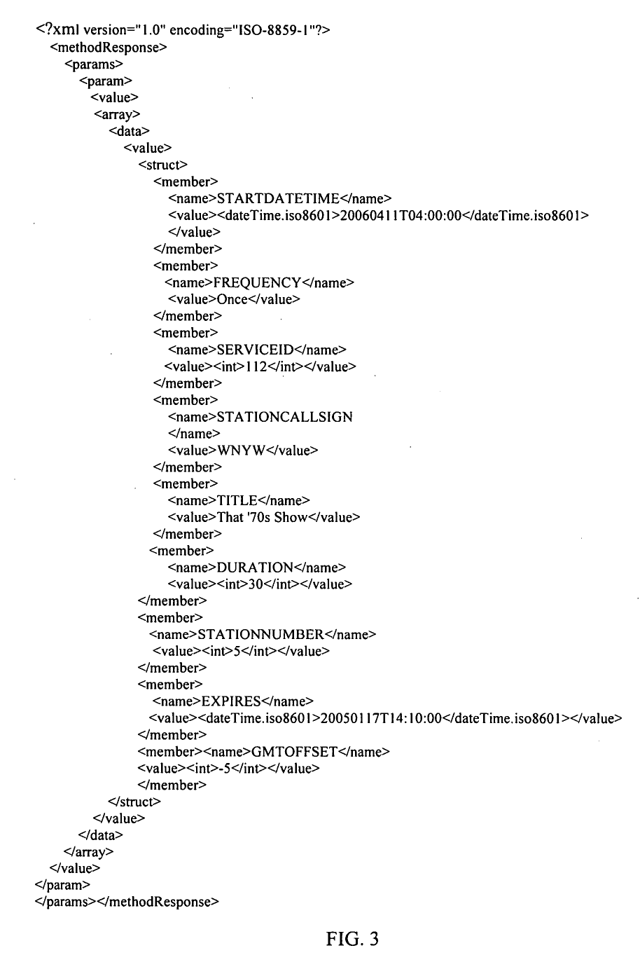

Server response messages deliver requested information to the client, and may include specific instructions. FIG. 3 is an example of a server response record instruction message in XML-RPC format. The record instruction response message contains the data utilized by the client to schedule a recording on the DVR, and is presented to the client for retrieval in response to a client request message of the type described above.

A preferred system utilizing the communication protocol would include several components. The number and type of components that are utilized depends on the functionality desired. Preferred components include: 1) a repository capable of storing user historical data; 2) a repository capable of storing data that the record instructions will refer to; 3) an external server capable of receiving and responding to requests made by clients (in the ‘client/server’ sense of the word) using the communication protocol; 4) a transport medium capable of transmitting communication protocol messages; 5) a uniquely addressable DVR Device, which implements the communication protocol; 6) a recommendation job provider (e.g., recommendation engine software or 3^{rd} parties, such as editorial content providers who critique and rate television programs); and 7) when implemented in the context of a broadcast network—a scheduling algorithm to optimize the delivery of record instructions to DVR devices.

The preferred implementation for the user repository is a relational database for storing user related information. A preferred relational database management system for the user repository is MySQL (www.mysql.com).

The preferred implementation for the data repository is a relational database for storing program listings information. The program listings information stored can be licensed from a data provider. A preferred relational database management system for the user repository is MySQL (www.mysql.com).

In an IP (TCP/IP) based network, the preferred server implementation is an XML-RPC server. Both the client and server interfaces to XML-RPC can be implemented in many different programming languages. A preferable server is a Java server, but other server platforms, even something other than XML-RPC, can be utilized.

In a broadcast (aka DVB/ATSC) network, it is likely that the server will send messages formatted in such a way as to optimize bandwidth utilization. A subset of the DVR devices may have the ability to send messages to the external server, and in those circumstances the DVR devices will preferably conform to whatever specifications are required by the server. It is also possible that the external server will be able to receive and send messages in multiple formats.

For IP-based networks the communication protocol preferably uses XML-RPC, as dictated by the current server implementation. Communication protocol messages are formatted as XML and sent via the HTTP communication protocol to the XML-RPC server(s). As mentioned above, there are many XML-RPC-supported languages for both the client and server components.

Preferably whatever format the external server uses, clients wishing to send messages to this server and receive messages from this server use this format as well.

The communication protocol is a client/server-based product. As such it assumes, at the very least, the capability of sending messages from the server to the client. In addition, it is preferred that clients are able to send messages to the server. The feature set possible is larger when clients can send messages to the server. For example, if a client can send messages to the server, then a client can send a message to the server confirming that it scheduled a record request. Conversely, if a client cannot send messages to the server, it is not possible to confirm that a client received a record request instruction.

In order to be able to send record instructions targeted to a specific user, the user during the registration process is preferably provided a unique identifier associated with his/her DVR device. Typically, this identifier would be supplied by the device manufacturer. This is especially preferable in a broadcast network where all the messages for every user are broadcast on the network, and it's the job of each DVR device to only retrieve the messages intended for it.

The unique identifier is less of an issue when the network is a broadband network, where requests are sent, received and returned in the context of a point-to-point connection. Nonetheless, preferably each DVR device has a unique Device ID.

The recommendation job provider provides users with recommendations for television programs to record. Depending on the implementer's requirements, recommendations can be generated several ways. Preferably, recommendations can be: 1) explicitly chosen by the implementer; 2) generated by a 3rd party; and/or 3) generated by a recommendation engine, which is a software product, that uses sophisticated algorithms to make recommendations based on various inputs (user likes/dislikes, viewing habits of user in question and/or viewing habits of other users).

The above list is not meant to be exhaustive, and other methods are possible. It is also possible to generate recommendations by using a combination of the methods outlined above.

Regardless of where the recommendations come from, the recommendation are preferably sent directly to individual users. The recommendations can be sent or retrieved using the communication protocol, any number of ways, including, but not limited to, a user's email, a dedicated application on the user's cell phone and/or personal digital assistant (PDAs), as a recording to a user's phone, etc.

Once a user has received one or more recommendations, s/he can choose to accept a recommendation. Upon the user's acceptance of a recommendation, a message is sent back to the external server using the communication protocol, resulting in that recommendation becoming a record instruction which, depending upon the characteristics of the network the user's DVR is on, will either subsequently be sent to or retrieved by that user's DVR device.

The service may also provide the ability for the user to explicitly identify a television program s/he wishes to record. This identification can occur in any number of ways, including, but not limited to, sending an email, using a dedicated application on a cell phone or PDA, by using a website, by calling a special phone number which retrieves a user's explicit record request, etc.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all written publications, all U.S. and foreign patents and patent applications, and all published statutes and standards, are specifically and entirely incorporated by reference. It is intended that the specification and examples be considered exemplary only with the true scope and spirit of the invention indicated by the following claims.

1. A system for scheduling recordings on a client electronic device comprising:
a server configured to send a message comprising instructions to record a program to a client electronic device utilizing a predetermined protocol, wherein the predetermined protocol is configured to permit communication between a server and a client electronic device and enables remote scheduling of recording on the client device;
a network that provides a communication link between the server and a client electronic device;
a client electronic device configured to receive the message from the server utilizing the predetermined protocol, and wherein the client device comprises a unique Device ID; and
an application on the client electronic device configured to execute the instructions to record the program on the client electronic device.

2. The system of claim 1, wherein the network is a one-way broadcast network.

3. The system of claim 2, wherein the broadcast stream is a program stream of a cable or satellite television system.

4. The system of claim 1, wherein the network is a two-way internet connection.

5. The system of claim 1, wherein the client electronic device is a digital recording device.

6. The system of claim 1, wherein the client electronic device is a digital video recorder.

7. The system of claim 1, wherein the recording device is configured to transmit a message to the server.

8. The system of claim 7, wherein the message comprises a recording conflict alert or a scheduling confirmation.

9. The system of claim 1, wherein the message is in XML-RPC format.

10. The system of claim 1, wherein the client electronic device is configured to provide its unique Device ID to the server prior to the server sending a message to the client electronic device.

11. The system of claim 1, wherein the message comprises the client electronic device's unique Device ID.

12. The system of claim 1, wherein the message comprises a unique message ID, timestamp, version of the communication protocol, and message type ID.

13. A method for scheduling recordings on a client electronic device comprising:
receiving on a client electronic device a message comprising instructions to record a program utilizing a predetermined protocol, wherein the client electronic device comprises a unique Device ID; and
executing the instructions to record the program on the on the client electronic device utilizing an application of the client electronic device.

14. The method of claim 13, wherein message is received over a network connection.

15. The method of claim 14, wherein the network is a one-way broadcast network.

16. The method of claim 15, wherein the broadcast stream is a program stream of a cable or satellite television system.

17. The method of claim 14, wherein the network is a two-way internet connection.

18. The method of claim 13, wherein the client electronic device is a digital recording device.

19. The method of claim 13, wherein the client electronic device is a digital video recorder.

20. The method of claim 13, further comprising transmitting a message from the client electronic device to the server.

21. The method of claim 20, wherein the message comprises a recording conflict alert or a scheduling confirmation.

22. The method of claim 13, wherein the message is in XML-RPC format.

23. The method of claim 13, wherein the client electronic device is configured to provide its unique Device ID to the server prior to the server sending the message to the client electronic device.

24. The method of claim 13, wherein the message comprises the client electronic device's unique Device ID.

25. The method of claim 13, wherein the message comprises a unique message ID, timestamp, version of the communication protocol, and message type ID.
